(19) United States
(12) Patent Application Publication
(10) Pub. No.: US 2021/0129864 A1
(43) Pub. Date: May 6, 2021

(54) SYSTEM AND METHOD FOR LANE MONITORING AND PROVIDING LANE DEPARTURE WARNINGS

(71) Applicant: SZ DJI TECHNOLOGY CO., LTD., Shenzhen (CN)

(72) Inventor: Mingyu WANG, Shenzhen (CN)

(21) Appl. No.: 17/097,269

(22) Filed: Nov. 13, 2020

Related U.S. Application Data
(63) Continuation of application No. PCT/CN2019/079329, filed on Mar. 22, 2019.

(51) Int. Cl. B60W 60/00; G06K 9/00; H04W 4/40

(52) U.S. Cl. CPC B60W 60/001; G06K 9/00798; B60W 2552/53; B60W 2420/403; B60W 2552/20; H04W 4/40

(57) ABSTRACT

Techniques for monitoring vehicle traffic are disclosed. A vehicle monitoring system comprises one or more sensing devices disposed within a vicinity of one or more vehicles in a road environment and one or more sensors on-board the one or more sensing devices, wherein said one or more sensors operate to collect information of the one or more vehicles in the road environment. Furthermore, the vehicle monitoring system comprises a data manager, running on one or more microprocessors, wherein the data manager operates to receive the collected information of the one or more vehicles, and analyze the collected information of the one or more vehicles to monitor the one or more vehicles in the road environment.

### CROSS REFERENCE TO RELATED APPLICATION

This application is a continuation of International Application PCT/CN2019/079329, filed Mar. 22, 2019, entitled, “SYSTEM AND METHOD FOR LANE MONITORING AND PROVIDING LANE DEPARTURE WARNINGS” which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosed embodiments relate generally to monitoring driving state and more particularly, but not exclusively, to lane monitoring and providing lane departure warnings using a plurality of lane departure warning system sensors.

### BACKGROUND

Vehicle status monitoring systems are important for ensuring safety and smooth traffic flows in road operations, which are key challenges for local authorities and road system operators. It is critical to acquire accurate data on the real-world usage of the road system and garner present knowledge of the events that may have an effect on the operations. Individual vehicles may also include assisted driving features that can identify the current vehicle's status and provide information to the driver based on that status, to aid the driver in safely operating the vehicle. This is the general area that embodiments of the invention are intended to address.

### SUMMARY

Described herein are systems and methods that can provide lane departure warnings based on vibration data. A system for generating lane departure warnings can include a plurality of sensors coupled to a vehicle, the plurality of sensors coupled to the vehicle in at least two bilateral locations, and a computing device coupled to the vehicle, the computing device in communication with the plurality of sensors. The computing device can include at least one processor and a driving manager. The driving can include instructions which, when executed by the processor, cause the driving manager to obtain vibration data from a plurality of sensors, process the vibration data to identify a vibration signal and vibration signal characteristics, determine the vibration signal is associated with a first bilateral location from the at least two bilateral locations, determine the vibration signal corresponds to a lane departure vibration signal based on the vibration signal characteristics, and send a lane departure warning message.

### BRIEF DESCRIPTION OF DRAWINGS

FIG. 1 shows an exemplary vehicle monitoring system, in accordance with various embodiments of the invention.

FIG. 2 shows an exemplary illustration of a plurality of sensing devices disposed in a road environment, in accordance with embodiments of the invention.

FIG. 3 shows using a sensing device to capture license plate information from a close vicinity, in accordance with embodiments of the invention.

FIG. 4 shows an exemplary sensing device that is disposed on the ground, in accordance with various embodiments of the invention.

FIGS. 5a-d show exemplary sensing devices with different configurations, in accordance with embodiments of the invention.

FIG. 6 shows monitoring and controlling a vehicle using an exemplary vehicle monitoring system, in accordance with embodiments of the invention.

FIG. 7 shows an exemplary data communication scheme for a vehicle monitoring system, in accordance with various embodiments of the invention.

FIG. 8 shows a flowchart of monitoring vehicle traffic, in accordance with various embodiments of the invention.

FIG. 9 shows a movable object operating in a road environment, in accordance with various embodiments of the invention.

FIG. 10 shows a movable object architecture, in accordance with various embodiments of the invention.

FIG. 11 shows a lane departure warning system (LDWS), in accordance with various embodiments of the invention.

FIG. 12 shows a movable object including LDWS sensors, in accordance with various embodiments of the invention.

FIG. 13 shows a flowchart of monitoring vehicle traffic, in accordance with various embodiments of the invention.

FIG. 14 is an exemplary illustration of a movable object, in accordance with various embodiments of the present invention.

### DETAILED DESCRIPTION

The invention is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

The description of the invention as following uses vision sensors or cameras as examples for sensors. It will be apparent to those skilled in the art that other types of sensors can be used without limitation.

In accordance with various embodiments of the present invention, a technical solution can be provided for monitoring vehicle traffic in a road environment. The vehicle monitoring system comprises one or more sensing devices disposed within a vicinity of one or more vehicles in a road environment and one or more sensors on-board the one or more sensing devices, wherein said one or more sensors operate to collect information of the one or more vehicles in the road environment. Furthermore, the vehicle monitoring system comprises a data manager, running on one or more microprocessors, wherein the data manager operates to receive the collected information of the one or more vehicles, and analyze the collected information of the one or more vehicles to monitor the one or more vehicles in the road environment. Such a technical solution can be used to better appreciate the behaviors of personnel involved in vehicle operation, model traffic flows, enable mission-critical traffic control systems (such as centralized traffic management systems), and enable smooth traffic control decision making in real-time.

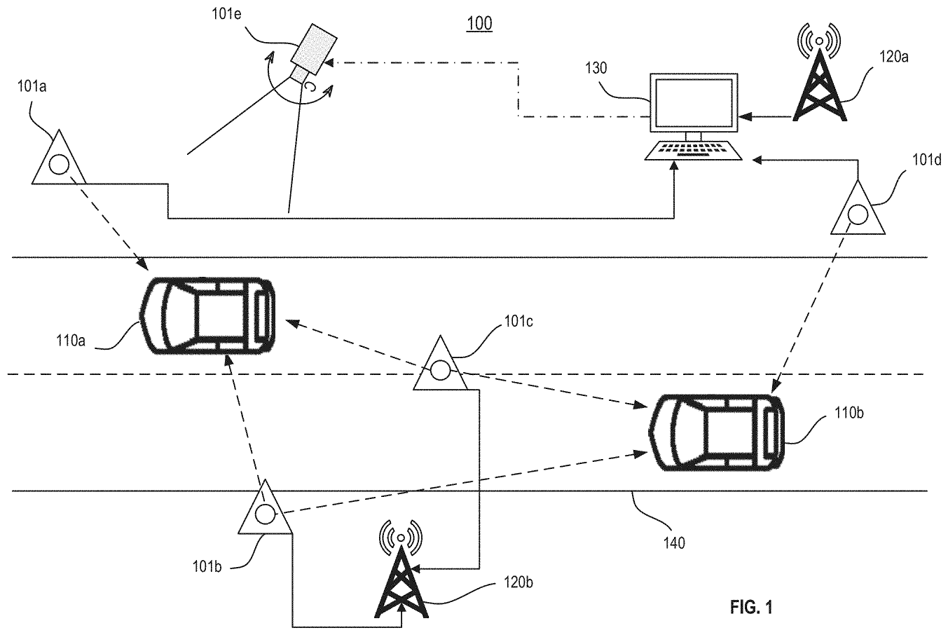

FIG. 1 shows an exemplary vehicle monitoring system, in accordance with various embodiments of the invention. The vehicle monitoring system 100 may comprise one or more sensing devices 101a-e capable of obtaining data about one or more vehicles 110a-b. The one or more sensing devices 101a-e may communicate the collected data to a traffic controller, such as a data center 130, over a communication infrastructure, which may comprise various communication devices such as communication devices 120a-b.

A sensing device 101a-e may obtain data about one or more vehicles 110a-b. Any description herein of obtaining data about one or more vehicles may include collecting movement and behavior data about the one or more vehicles with aid of one or more sensors on-board the sensing device. For instance, any description herein of obtaining data about one or more vehicles may include collecting movement and behavior data via communications with the vehicle. Any description herein of obtaining movement and behavior data about a vehicle may comprise collecting any type of movement and behavior data.

As shown in FIG. 1, one or more vehicles 110a-b are operating in a road environment 140. Different sensing devices are disposed within the road environment 140 for monitoring the traffic. For example, sensing devices 101a-c are able to detecting and monitoring the vehicle 110a, and sensing devices 101b-d are able to detecting and monitoring the vehicle 110b. Additionally, a sensing device 101e can be configured to adjust its angle and/or position for tracking or otherwise dynamically monitoring the traffic on the section of road 140 in real-time. The sensing device may obtain data about one or more vehicles that are within a detectable range of the sensing device.

In some embodiments, a sensing device may perform pre-processing or analysis of the data obtained by one or more sensors on-board the sensing device. The sensing device may perform pre-processing or analysis with aid of an on-board analyzer. The on-board analyzer may comprise one or more processors in communication with one or more sensors on-board the sensing device.

The on-board analyzer may pre-process information from one or more sensors by putting the data into a desired format. In some instances, the on-board analyzer may receive raw data from one or more sensors and convert the raw data into data of a form that may be indicative of positional or behavior data of the one or more vehicles. The on-board analyzer may convert behavior data to positional information, such as positional information relative to the sensing device, or positional information relative to an inertial reference frame, or vice versa. The on-board analyzer may correlate the behavior data with positional information, and/or vice versa. Different sensors may optionally output different types of data. The data may be converted to a form that may be consistent and comparable.

The on-board analyzer may optionally compare information from multiple sensors to detect how the vehicle is actually moving or behaving. The sensing devices may optionally utilize a single type of sensors. Alternatively, the sensing devices may utilize multiple types of sensors. The sensing devices may utilize sensor fusion techniques to determine how the vehicle is behaving. The sensing devices may utilize simultaneous location and mapping (SLAM) techniques to determine how the vehicle is moving or behaving. For instance, the sensing device may utilize vision sensors and ultrasonic sensors to detect vehicles. The vision sensors may be utilized in combination with the ultrasonic sensors to determine positional information pertaining to the vehicles. Any combination of one or more of the various types of sensors described elsewhere herein may be utilized to determine how the vehicle is moving or behaving. In some embodiments, there may be slight inconsistencies or discrepancies in data collected by the multiple sensors.

The vehicle monitoring system 100 may weight data from one or more sensors such that data from sensors with typically greater accuracy or precision may receive a higher weight than data from sensors with typically lesser accuracy or precision. Optionally, a confidence level may be associated with data collected by one or more sensors. When there are inconsistencies in data, there may be a lower confidence associated with the data that the data is accurate. When there are a greater number of sensors with consistent data, there may be a higher confidence associated with the data that the data is accurate, compared to when there are a fewer number of sensors with consistent data.

The on-board analyzer may or may not analyze the data obtained by the sensing device. For instance, the on-board analyzer may analyze positional information about the vehicle to categorize the vehicle's behavior. The on-board analyzer may recognize various driving behaviors. The on-board analyzer may utilize pattern recognition and/or artificial intelligence to recognize various driving behaviors. In some instances, neural networks, such as CNN or RNN may be employed. The on-board analyzer may recognize safe driving behavior and unsafe driving behavior. The on-board analyzer may recognize illegal driving behavior. In some instances, illegal driving behavior may be an example of unsafe driving behavior. The on-board analyzer may recognize when a vehicle is speeding, running through a red light, running through a stop sign, making unsafe stops, making an illegal turn, cutting off another vehicle, not yielding right-of-way, going the wrong way on a one-way street, or getting into a collision with another vehicle, a stationary object, or a pedestrian. The on-board analyzer may optionally detect contextual information relating to a vehicle's behavior. For example, the on-board analyzer may detect whether the vehicle is making an unsafe movement such as a swerve for no reason, or if the swerve is necessary to avoid collision with another object. In another example, the on-board analyzer may detect whether the vehicle is illegally stopping on the side of the road, or whether the vehicle pulled over to allow an emergency vehicle to pass.

An on-board analyzer may optionally be capable of modeling the environment, detecting surrounding cars, determining whether the surrounding cars have safe or unsafe driving behaviors (e.g., illegal driving behavior), and/or generating abnormal driving behavior description information (e.g. in real-time). Alternatively, any of these functions may be performed at a data center.

Alternatively, the sensing device may not have an on-board analyzer. The sensing device may directly transmit raw data to an off-board data center. The off-board data center may perform any of the tasks described for the on-board analyzer. In some embodiments, a sensing device may have an on-board analyzer that may perform some steps for collecting and processing the data. An off-board analyzer, such as a data center, may perform other collecting and processing steps. For example, the on-board analyzer may pre-process data, while the data-center may analyze the data to recognize behavior of the one or more vehicles. The data center may be remote to the sensing device.

Optionally all data may be utilized, analyzed, stored and/or transmitted. Alternatively, data reduction techniques may be used. In some instances, only a subset of the data may be recorded at the outset. For instance, a sensing device may only record data that seems interesting or relevant. A sensing device may only record data that is relevant to detecting instances of unsafe or safe driving behaviors, or other categories of driving behavior, as described elsewhere herein. The sensing device may only record data that may seem relevant to the other functions or applications of the vehicle monitoring system as described elsewhere herein. In some instances, the sensing device may only share data that seems interesting or relevant with a data center. The sensing device may or may not store all of the data, but may share only the data that seems interesting or relevant with the data center. The sensing device may only transmit data to a data center that seems relevant to detecting instances of unsafe or safe driving behaviors, or other categories of behavior, as described elsewhere herein. The sensing device may only transmit data that may seem relevant to the other functions or applications of the vehicle monitoring system. This may also apply to data that may be transmitted to and/or shared with other vehicles in addition to or as an alternative to the data transmitted to the data center. The data center may record all of the data that is transmitted to the data center. Alternatively, the data center may only record a subset of the data received. For instance, a data center may only record data that seems interesting or relevant. A data center may only record data that is relevant to detecting instances of unsafe or safe driving behaviors, or other categories of driving behavior, as described elsewhere herein. The data center may only record data that may seem relevant to the other functions or applications of the vehicle monitoring system as described elsewhere herein. In some embodiments, any duplicative information may be deemed irrelevant and need not be recorded and/or transmitted. Irrelevant data may be filtered out.

Raw data may be recorded and/or transmitted. For example, if the sensors are image sensors, the images captured by the sensors may be recorded and/or transmitted. The images may then be analyzed to detect any relevant behavior. In some instances, the data may be converted to a reduced form at the outset. For instance, a sensing device may only record the analysis of the data that is interesting or relevant. A sensing device may only record descriptions of instances of unsafe or safe driving behaviors, or other categories of driving behavior, as described elsewhere herein. The descriptions may use less memory than the raw data. For instance, a label indicating “speeding” may take less memory than a still image or video clip showing the vehicle speeding. The descriptions may be stored as text or in any other format. The descriptions may include any level of specificity. For examples they may include category of behavior (e.g., speeding, running red light, unsafe merge, unsafe lane change, not stopping for stop sign, not yielding to pedestrians, etc.), time at which the behavior occurred, location at which the behavior occurred, and/or information about the vehicle performing the behavior (e.g., vehicle identifier such as license plate, color of vehicle, make of vehicle, mode of vehicle, vehicle brand, vehicle type). The sensing device may only record descriptions that may seem relevant to the other functions or applications of the vehicle monitoring system as described elsewhere herein. In some instances, the sensing device may only share analysis of the data that seems interesting or relevant with a data center. The sensing device may or may not store all of the data, but may share only the description of the behavior that seems interesting or relevant with the data center. The sensing device may only transmit descriptions to a data center that are indicative of instances of unsafe or safe driving behaviors, or other categories of behavior, as described elsewhere herein. The sensing device may only transmit descriptions that may seem relevant to the other functions or applications of the vehicle monitoring system as described elsewhere herein. This may also apply to descriptions that may be transmitted to and/or shared with other vehicles in addition to or as an alternative to the descriptions transmitted to the data center. The data center may record all of the descriptions that are transmitted to the data center. Alternatively, the data center may only record a subset of the descriptions received. For instance, a data center may only record descriptions that seems interesting or relevant. In some instances, all data may be transmitted to the data center and the data center may analyze the data to generate relevant descriptions. A data center may only record descriptions that are relevant to detecting instances of unsafe or safe driving behaviors, or other categories of driving behavior, as described elsewhere herein. The data center may only record descriptions that may seem relevant to the other functions or applications of the vehicle monitoring system as described elsewhere herein.

The sensing device 100 may communicate with a data center 130 with aid of communication infrastructure, which may comprise various communication devices such as communication devices 120a-b. The sensing devices may communicate with the data center wirelessly. A wireless communication may include data from the sensing device to the data center and/or data from the data center to the sensing device. In some embodiments, one-way communication may be provided. For example, data about one or more vehicles obtained by the sensing device may be communicated to the data center. Optionally, communications from the sensing device to the data center may comprise data about the sensing device itself, a driver of the sensing device, and/or a driver of the vehicle. The communications may or may not include analyzed behavior data of the vehicle and/or the sensing device. In some embodiments, two-way communication may be provided. For example, data obtained by the sensing device may be sent from the sensing device to the data center, and data from the data center may be sent to the sensing devices. Examples of data from the data center may include, but are not limited to, data about the one or more vehicles, data about one or more environmental conditions (e.g., weather, traffic, accidents, road conditions), or commands that affect operation of the sensing device (e.g., driver's assistance, autonomous or semi-autonomous driving).

The communication between the sensing device and the data center may be a direct communication. A direct communication link may be established between the sensing device (such as sensing device 101a, 101d and 101e) and the data center 130. The direct communication link may remain in place while the sensing device is in operation. The data center may be stationary or in motion. The sensing device may be moving independently of the data center. Any type of direct communication may be established between the sensing device and the data center. For example, WiFi, WiMax, COFDM, Bluetooth, IR signals, or any other type of direct communication may be employed. Any form of communication that occurs directly between two objects may be used or considered.

In some instances, direct communications may be limited by distance. Direct communications may be limited by line of sight, or obstructions. Direct communications may permit fast transfer of data, or a large bandwidth of data compared to indirect communications.

The communication between the sensing device and the data center may be an indirect communication. Indirect communications may occur between the sensing device (such as the sensing devices 101b-c) and the data center 103 with aid of one or more intermediary devices. In some examples the intermediary device may be a satellite, router, tower, relay device, or any other type of device. Communication links may be formed between a sensing device and the intermediary device and communication links may be formed between the intermediary device and the data center. Any number of intermediary devices may be provided, which may communicate with one another. In some instances, indirect communications may occur over a network, such as a local area network (LAN) or wide area network (WAN), such as the Internet. In some instances, indirect communications may occur over a cellular network, data network, or any type of telecommunications network (e.g., 3G, 4G, LTE). A cloud computing environment may be employed for indirect communications.

In some instances, indirect communications may be unlimited by distance, or may provide a larger distance range than direct communications. Indirect communications may be unlimited or less limited by line of sight or obstructions. In some instances, indirect communications may use one or more relay device to aid in direct communications. Examples of relay devices may include, but are not limited to satellites, routers, towers, relay stations, or any other type of relay device.

A method for providing communications between a sensing device and a data center may be provided, where the communication may occur via an indirect communication method. The indirect communication method may comprise communication via a mobile phone network, such as a LTE, 3G or 4G mobile phone network. The indirect communications may use one or more intermediary devices in communications between the sensing device and the data center. The indirect communication may occur when the sensing device is in operation.

Any combination of direct and/or indirect communications may occur between different objects. In one example, all communications may be direct communications. In another example, all communications may be indirect communications. Any of the communication links described and/or illustrated may direct communication links or indirect communication links. In some implementations, switching between direct and indirect communications may occur. For example, communication between a sensing device and a data center may be direct communication, indirect communication, or switching between different communication modes may occur. Communication between any of the devices described (e.g., vehicle, data center) and an intermediary device (e.g., satellite, tower, router, relay device, central server, computer, tablet, smartphone, or any other device having a processor and memory) may be direct communication, indirect communication, or switching between different communication modes may occur.

In some instances, the switching between communication modes may be made automatically without requiring human intervention. One or more processors may be used to determine to switch between an indirect and direct communication method. For example, if quality of a particular mode deteriorates, the system may switch to a different mode of communication. The one or more processors may be on board the sensing device, part of a data center, on board a third external device, or any combination thereof. The determination to switch modes may be provided from the sensing device, the data center, and/or a third external device.

In some instances, a preferable mode of communication may be provided. If the preferable mode of communication is un-operational or lacking in quality or reliability, then a switch may be made to another mode of communication. The preferable mode may be pinged to determine when a switch can be made back to the preferable mode of communication. In one example, direct communication may be a preferable mode of communication. However, if the sensing device drives too far away, or obstructions are provided between the sensing device and the data center, the communications may switch to an indirect mode of communications. In some instances, direct communications may be preferable when a large amount of data is transferred between the sensing device and the data center. In another example, an indirect mode of communication may be a preferable mode of communication. If the sensing device and/or data center needs to quickly transmit a large amount of data, the communications may switch to a direct mode of communications. In some instances, indirect communications may be preferable when the sensing device at significant distances away from the data center and greater reliability of communication may be desired.

Switching between communication modes may occur in response to a command. The command may be provided by a user. The user may be an operator of the sensing device. The user may be an individual at a data center or operating a data center.

In some instances, different communication modes may be used for different types of communications between the sensing device and the data center. Different communication modes may be used simultaneously to transmit different types of data.

The data center 130 may receive and store information collected by the sensing device. As described elsewhere herein, the data center may comprise one or more processors that may receive and store information. The data center may receive and store information collected by multiple sensing devices. The data center may receive and store information regarding one or more vehicles collected by the multiple sensing devices. The data center may receive information directly from the sensing device or vehicles, or may receive the information indirectly from the sensing device or vehicles. The data center may receive the information with aid of a communication infrastructure. In one example, a virtual private network (VPN) may be utilized in providing the information to a data center. The data center may receive any information obtained by one or more sensing devices. The information may include obtained about one or more vehicles, the sensing device itself, or an environment around the sensing device. The information may include information about a driver or any other individual associated with the one or more vehicles and/or the sensing device. The information may include a driver identifier and/or vehicle identifier of the sensing device or the one or more vehicles. Any information described elsewhere herein may be included.

The data center may receive and/or provide context or circumstances at which the information is obtained. For example, the data center may receive contextual information, such as time or location information at which the information was collected. For example, a sensing device may provide information indicating a time when data about the vehicle was collected. The time may be provided in any format. For instance, the time may be provided in hours, minutes, seconds, tenths of seconds, hundredths of seconds, and/or milliseconds. The time may include a day of the week, date (e.g., month, day of the month, year). The time may include time zone information (e.g., whether the information was collected at Eastern Standard time, Coordinated Universal time, etc.). The time may be provided as a time stamp. The time stamp may be provided based on a time keeping device (clock) on-board the sensing device. The time stamp may be provided based on a time keeping device off-board the sensing device, such as a satellite, server, the vehicle, data center, or any other reference device.

Similarly, a sensing device may provide a location at which data about the vehicle was collected. The location may include a location of the vehicle relative to the sensing device and/or relative to an inertial reference frame. Alternatively or in addition, the location may include a location of the sensing device. The location of the sensing device may be within an inertial reference frame or relative to any reference point. The location may be provided in any format. For instance, the location may be provided as geospatial coordinates. The coordinates may be relative to an inertial reference frame, such as latitude, longitude, and/or altitude. Examples of coordinates systems may include, but are not limited to, Universal Transverse Mercator (UTM), Military Grid Reference System (MGRS), United States National Grid (USNG), Global Area Reference System (GARS), and/or World Geographic Reference System (GEOREF). The location may be provided as distance and/or direction relative to a reference point, such as a sensing device.

The contextual information, such as time and/or location, may be gathered by the sensing device when the sensing device obtains the information. The contextual information may be provided by a vehicle when the vehicle communicates with the sensing device. The contextual information may be provided by a sensing device when the sensing device sends information to the data center. The contextual information may be provided by the data center when the data center receives information from the sensing device.

Additional examples of contextual information may include, but are not limited to, environmental conditions, such as weather, precipitation, traffic, known accidents, local events (e.g., street fairs, etc.), power blackouts, or original source of information (e.g., sensor on-board sensing device, identity of vehicle, external sensors), or any other type of contextual information.

For example, the data center may provide a time stamp, or any other type of time information, when the data center receives information from the sensing device. The sensing device may provide information to the data center in substantially real-time as the sensing device has obtained the data about the one or more vehicles, and/or data about the sensing device. For instance, the sensing device may transmit information to the data center within half an hour, 15 minutes, 5 minutes, 3 minutes, 2 minutes, 1 minute, 30 seconds, 15 seconds, 10 seconds, 5 seconds, 3 seconds, 2 seconds, 1 second, 0.5 seconds, 0.1 seconds, 0.05 seconds, 0.01 seconds, or 0.001 seconds of obtaining the data bout the one or more vehicles and/or sensing device (e.g., with aid of one or more sensors, and/or communications with the one or more vehicles).

The sensing device may provide information to the data center while the sensing device is in operation. The sensing device may provide information while the sensing device is powered on. In some instances, the sensing device may provide information for substantially an entire period that the sensing device is powered on. The sensing device may provide information while the sensing device is in operation. In some instances, the sensing device may provide information for substantially an entire period that the sensing device is in motion. In some instances, the sensing device may provide information substantially continuously, at predetermined time intervals, or in response to one or more events. For example, the sensing device may provide information only when the sensing device has pre-analyzed the information and detected unsafe driving behavior.

The data center may aggregate information received by the one or more sensing devices. The data center may associate and/or index information by any aspect of the information, (e.g., behavior data of the vehicle, vehicle identity, vehicle driver identity, sensing device identity, sensing device driver identity, or contextual information).

The data center may analyze the information received from the one or more sensing devices. The data center may recognize patterns or behavior over time. The data center may be able to generate a safe driving index for one or more vehicles. The data center may be able to generate a safe driving index for one or more drivers. The safe driving index for the one or more vehicles may be provided on a vehicle by vehicle basis without regard to the identity of a driver of the vehicle. The safe driving index for one or more drivers may be provided on a person by person basis without regard to the identity of an identity of the vehicle driven by the driver. In other instances, the safe driving index may take into account both driver identity and vehicle identity (e.g., Person A seems to drive more safely with Vehicle A than Vehicle B, etc.).

The data center may comprise one or more computing devices. For example, the data center may comprise one or more servers, personal computers, mobile devices (e.g., smartphones, tablets, personal digital assistants), or any other type of device. In some examples, the data center may comprise one or more servers and/or databases. The data center may be provided at a single location or at multiple locations. The data center may be owned, controlled, and/or operated by a single entity. Alternatively, the data center may be owned, controlled, and/or operated by multiple entities. Any description herein of a function of the data center may be performed by a single device or multiple devices acting in concert. Any description herein of a data center may be performed a single location individually or multiple locations collectively. The data center may comprise one or more memory storage devices which may comprise non-transitory computer readable media that may comprise code, logic, or instructions, for performing one or more steps provided herein. The data center may comprise one or more processors which may execute code, logic or instructions to perform the one or more steps provided herein.

In alternative embodiments, any function of the data center may be performed by multiple segments or components. In some instances, any function of the data center may be performed by a cloud computing or peer-to-peer architecture. In one example, each sensing device may comprise an on-board analyzer, and the various sensing devices may communicate and share information with one another.

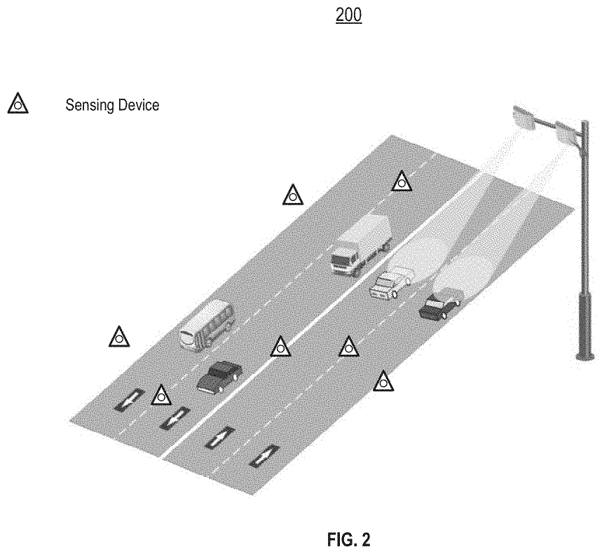

FIG. 2 shows an exemplary illustration of a plurality of sensing devices disposed in a road environment, in accordance with embodiments of the invention. As shown in FIG. 2, a vehicle monitoring system 200 may comprise a plurality of sensing devices (shown as triangular), which are capable of obtaining data about one or more vehicles. Additionally, the one or more sensing devices may communicate the collected data to a traffic controller, such as a data center, over a communication infrastructure.

Sensing devices, such as cameras or radars, may be placed on various structures in the road environment. In some instances, the sensing devices may be placed at various locations that are suit for photographing or detecting the vehicles. In one example, cameras or radars can be installed on traffic or signal poles. Using such a configuration, it may be challenging for the vehicle monitoring system to obtain detailed information about vehicles in the road environment since the camera radar is placed at a substantial distance away from the traffic. Also, the system may have special requirement for hardware equipment and recognition algorithms. For example, high-definition cameras may be required for capturing the license plate number information of the vehicles passing by the cameras or radars. Also, since the sensing devices are installed at position with a substantial distance above the ground surface, special equipment such as special lifting equipment may be required for maintenance. As a practical matter, these special lifting equipment may be difficult to operate and costly to maintain. Additionally, when the vehicle license plate is photographed using a camera, a flash light may be needed for capturing a clear picture. The flash light may interfere with the driver's line of sight and can become serious traffic safety hazards.

In accordance with various embodiments, various sensing devices can be disposed at various locations in the road environment that are suitable for collecting vehicle movement and behavior information. For example, the sensing devices can be disposed on the ground surface, which is closer to the traffic in space. Additionally, the sensing devices may be integrated into various types of traffic control devices. Such traffic control devices can include markers, signs and signal devices used to inform, guide and control traffic (including pedestrians, motor vehicle drivers and bicyclists traffic). The sensing devices may be placed adjacent to or within the highways, roads, facilities, and other areas or structures that require traffic control.

As shown in FIG. 2, the sensing devices can be disposed on the road, or various structures adjacent to the road such as barriers or delineators. For example, the sensing devices can be integrated with raised pavement markers that are used to supplement or replace pavement markings. The raised pavement markers may have embedded reflectors or may be non-reflective. Also, the sensing device can be integrated with delineators, which comprise small reflective panels mounted on lightweight metal posts or flexible plastic tubes that can be used to outline roadways and paths. In addition, the sensing devices can be installed on the facade of various building structures, such as overpassing bridges.

In various embodiments, the sensing devices can be disposed on various traffic barriers, which can be placed in critical area of the road environment to ensure safety. For example, the traffic barriers can be used for keeping vehicles within the road way for preventing the vehicles from colliding with dangerous obstacles such as boulders, sign supports, trees, bridge abutments, buildings, walls, and large storm drains, or from traversing steep (non-recoverable) slopes or entering deep water. The traffic barriers may also be installed within medians of divided highways to prevent errant vehicles from entering the opposing roadway of traffic and help to reduce head-on collisions. (For example, median barriers are designed to be struck from either side.) Traffic barriers can also be used to protect vulnerable areas like school yards, pedestrian zones, and fuel tanks from errant vehicles. Thus, by installing the sensing devices on various traffic barriers, the vehicle monitoring system can collect traffic information related the critical area of the road environment. Such information can also be used for achieving accident prevention and traffic improvement.

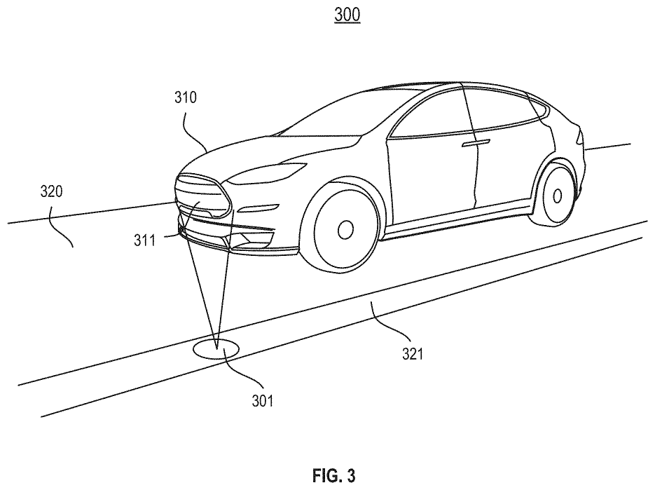

In various embodiments, a vehicle monitoring system may comprise one or more sensing devices that can collect information about one or more vehicles from a close vicinity. The sensing device may communicate the collected data to a traffic controller, such as a data center, over a communication infrastructure. FIG. 3 shows using a sensing device to capture license plate information from a close vicinity, in accordance with embodiments of the invention. As shown in FIG. 3, a ground camera 301 can be used for capturing critical information (such as license information 311) about a car 310 in the road environment 300. In various instances, the ground camera 301 can be disposed on a reflective belt 321 on the surface that separates the traffics in same or different directions on a road 320. For example, such reflective belt can be a reflective strip on a high way, a reflective strip in the middle of a double yellow line, and one of the reflective strips at the entrance of a facility such as a toll booth. Furthermore, the ground camera 301 can communicate the collected licensing plate data to a data center over a communication infrastructure.

By disposing the camera on the road surface such as reflective belts, it is possible to capture the license plate information of vehicles passing by more accurately, since the camera can be placed closer to the vehicle. Additionally, multiple sensing devices with similar configurations can be disposed in the same section of the road, so that the system can collect more information about the vehicles passing by in order to monitor and control the traffic more effectively.

In accordance with various embodiments, a sensing device can be configured to operate in different modes for achieving optimal outcome. The sensing device (e.g. a camera or radar) can operate in a low resolution mode when there is no vehicle within a predetermined distance (i.e. within a vicinity). For example, a camera in the low resolution mode can detect whether a vehicle is passing by and can estimate the location of the vehicle. The camera can switch to a high resolution mode when the vehicle is within the vicinity (e.g. when the vehicle reaches a predetermined or dynamically configured distance that suits for taking a picture). Additionally, in the high resolution mode, a flashlight may be applied at a right moment to improve the quality of the picture. Furthermore, the flashlight can be configured to be activated at a time and an angle that do not cause distraction to the driver of the vehicle. For example, since the camera is disposed on the ground, and the flashlight can avoid interfering the driver's line of sight and avoid distracting the driver of the vehicle passing by.

In accordance with various embodiments, a benefit for disposing a sensing device such as a camera in the reflective strip is that the sensing device can be placed adjacent to the path of traffic. In the meantime, such configuration can avoid direct impact from wheels of the vehicles in the traffic, which is helpful to reduce daily wear and tear. Additionally, the camera can be contained in a housing that is structurally stable and can better sustain daily wear and tear caused by the incidental impact from the traffic.

In accordance with various embodiments, the sensing devices, such as cameras, can be arranged at intervals along the reflective belt. Furthermore, each individual vehicle can be identified or distinguished, for example based on the license plate that may be visually recognized. Thus, the timing information can be recorded and shared corresponding to the license plate information. Thus, the speed of the vehicle can be measured based on the timing information related to when the vehicle is detected by the different cameras. For example, it is possible to measure the speed of this car according to the time difference and the relative position between two cameras which can be predetermined.

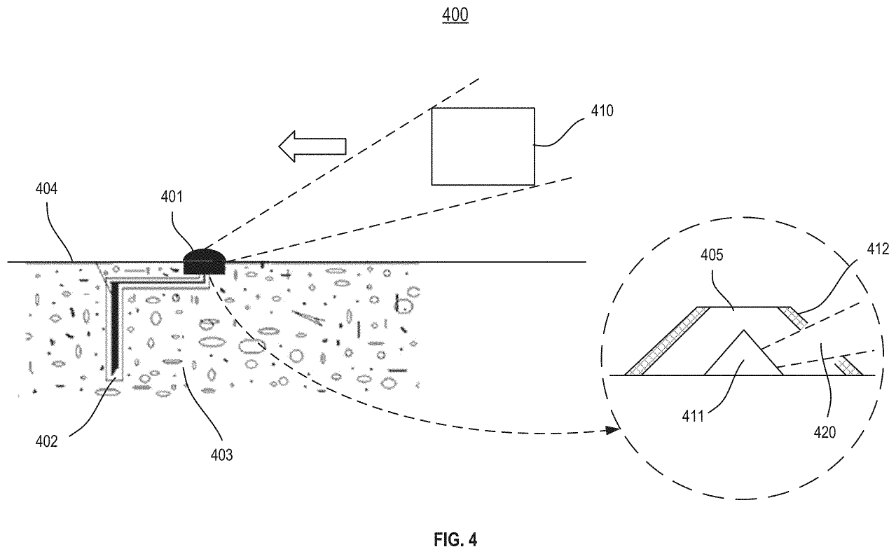

FIG. 4 shows an exemplary sensing device that is disposed on the ground, in accordance with various embodiments of the invention. As shown in FIG. 4, a sensing device 401 is capable of detecting, and collecting information about, one or more vehicles in the vicinity. For example, the sensing device 401 may be able to capture image of at least a portion of a vehicle 410.

In accordance with various embodiments, different methods can be used for disposing the sensing device 401 on the ground. Furthermore, the sensing device 401 may communicate the collected data to a controller or a data center over a communication infrastructure. As shown in FIG. 4, a sensing device 401 can be disposed on ground, such as on a pavement 401. Additionally, the sensing device 401 can be connected with necessary power supply and data communication infrastructures such as digital cables or optical fiber channels 402.

In accordance with various embodiments, a sensing device can be installed within a structure or device used in the road environment, such as a raised pavement marker 405. Alternatively, the raised pavement marker 405 can be constructed to include the sensing device. As shown in FIG. 4, the raised pavement marker 405 can comprise one or more reflective surfaces 412, which reflects light back to the driver in order to help the driver navigate in the road environment 400. The reflective surface 412 can be configured with one or more opening or a transparent portions 420 so that the sensing device, such as a sensor 411, within the raised pavement marker 405 can receive returned signal or light from the surrounding environment, in order for detecting and collecting information about the vehicle 410. In various embodiments, the opening or transparent portions 420 on the reflective surface 412 can be configured or oriented facing against the direction of traffic in order for detecting and collecting information about vehicles in the incoming traffic. Alternatively, the opening or transparent portions can be configured or oriented facing along the direction of traffic in order for detecting and collecting information about vehicles in the outgoing traffic. Also, the opening or transparent portions can be configured on multiple surfaces or on any surface in order for detecting and collecting information about vehicles in the traffic.

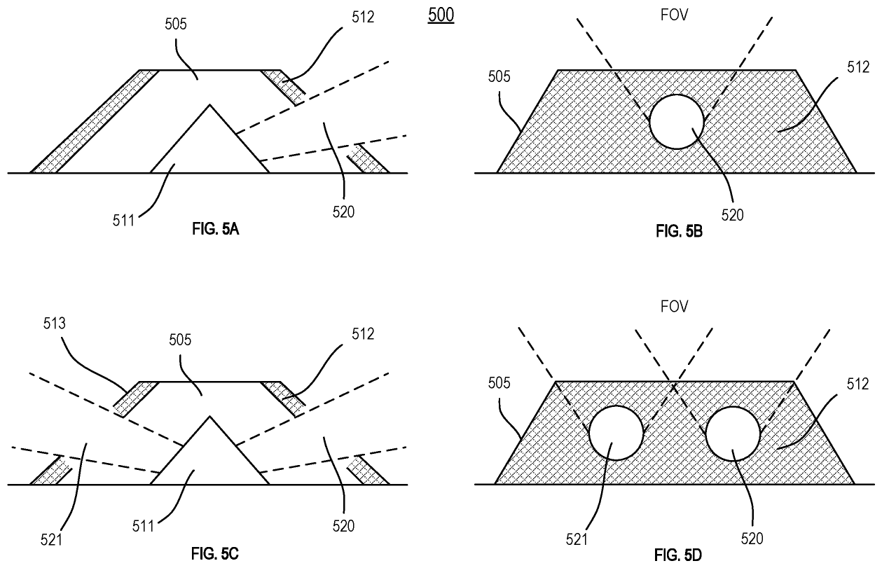

FIGS. 5a-d show exemplary sensing devices with different configurations, in accordance with embodiments of the invention. As shown in FIGS. 5(a) and 5(b), a sensing device 511 can be incorporated within a raised pavement marker 505. The sensing device 511 can collect vehicle information in the vicinity through an opening or transparent portion 520 on a surface, such as a reflective surface 512. In accordance with various embodiments, the opening or transparent portion 520 on the reflective surface 512 can be configured in various geometry shapes (e.g. a circle or a rectangle). Also, the size and shape of the opening or transparent portion 520 on a reflective surface 512 may be specially configured in order to achieve a desired field of view (FOV) for the sensing device 505.

In various embodiments, the sensing device 505 can be implemented using different configurations. As shown in FIG. 5(c), the raised pavement marker 505 may have opening or transparent portions 520-521 on different surfaces 512-513 (each of which may be configured as either reflective or non-reflective). Thus, the sensing device 511 can collect information from multiple angles or directions. Additionally or alternatively, as shown in FIG. 5(d), a single reflective surface 512 may have multiple opening or transparent portions 520-521, in order to increase the FOV or obtain additional information (such as for determining distance or speed of a vehicle using various computer vision technologies).

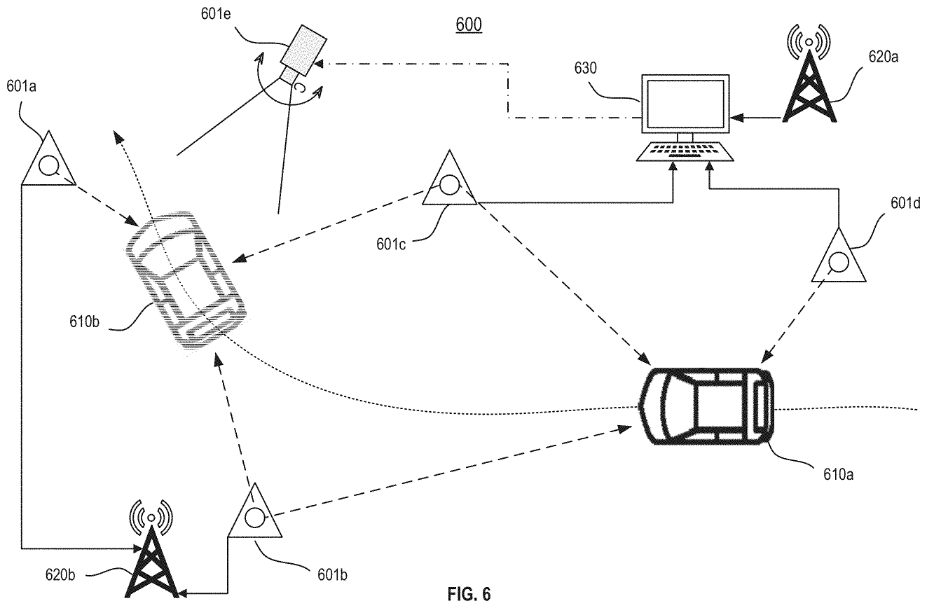

FIG. 6 shows monitoring and controlling a vehicle using an exemplary vehicle monitoring system, in accordance with embodiments of the invention. The vehicle monitoring system 600 may comprise a plurality of sensing devices 601a-e capable of collecting information about vehicles in a road environment. The sensing devices 601a-e may communicate the collected data to a traffic controller 630 such as a data center over a communication infrastructure.

In accordance with various embodiments, a vehicle monitoring system 600 can provide real-time observations of a road environment to a traffic controller 630 (which may be running in a data center). The traffic controller 630 in turn may generate precise road condition information and traffic information and communicate such information back to the vehicle for assisting or controlling the movement of the vehicle in the road environment. Alternatively, a controller on board the vehicle may receive at least portion of the information directly from the sensing devices 601a-e (or indirectly from the traffic controller 630). For example, a controller on board the vehicle may be able to receive real-time data from the sensors within a vicinity of a vehicle in the road environment. Additionally, the controller may be able to receive precise road condition information and traffic information such as high precision real-time road map from the traffic controller 630. Thus, the vehicle can be well-informed of the road environment in order to navigate safely within the road environment. In some embodiments, the vehicle can be an autonomous vehicle, which is able to navigate in the road environment based on its own sensing capability and the precise road and traffic condition information received from the traffic controller 630, in real-time.

As shown in FIG. 6, when the vehicle is at the first location 610a, the sensing devices 601b-d can detect the positional and behavior information with regard to the vehicle. The sensing devices 601b-d may communicate the collected sensing data to the traffic controller 630 over a communication infrastructure 620a-b. Thus, the traffic controller 630, which may be operating in a data center, can process the received information for monitoring road conditions and vehicle movement information. Furthermore, the traffic controller 630 can perform various types of data analysis in order to generate information for assisting or controlling the vehicle. In accordance with various embodiments, such information can be communicate to the vehicle via the communication infrastructure 620 (or via different communication infrastructures).

Further as shown in FIG. 6, the vehicle may move from the first location 610a to the second location 610b in the road environment. The sensing devices 601a-c can detect the positional and behavior information with regard to the vehicle, when the vehicle is at the second position 610b in the road environment. Furthermore, the plurality of sensing devices 601a-d may communicate the data collected to a data center 630 over a communication infrastructure 620a-b. Thus, the traffic controller 630, can process the received information for monitoring road conditions and vehicle movement information. Furthermore, the traffic controller 630 can perform various types of data analysis in order to generate information for assisting or controlling the vehicle. In accordance with various embodiments, such information can be communicate to the vehicle via the communication infrastructure 620 (or via different communication infrastructures).

In accordance with various embodiments of the invention, a vehicle monitoring system can take advantage of one or more sensing devices that are capable of collecting data about one or more vehicles. For example, a sensing device 601e can be configured to adjust its angle and/or position for tracking or otherwise dynamically monitoring the movement of the vehicle from position 610a to position 610b in real-time. The sensing device 601e may communicate the collected data to a traffic controller 630 such as a data center via a communication scheme 620a-b.

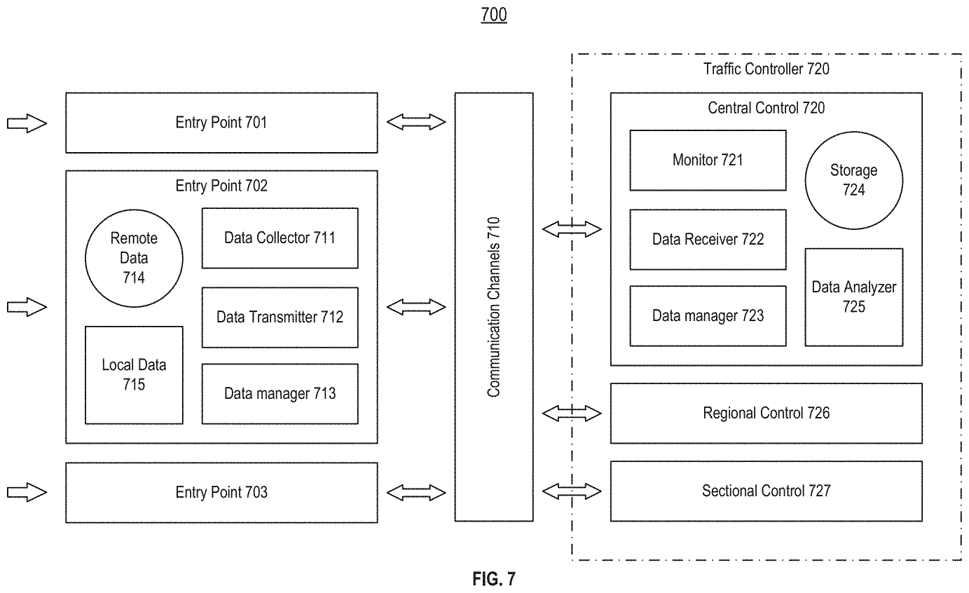

FIG. 7 shows an exemplary data communication scheme for a vehicle monitoring system, in accordance with various embodiments of the invention. As shown in FIG. 7, the data communication scheme 700 can take advantage of one or more entry points, such as entry points 701-703. Each entry point can be responsible for collecting data from one or more sensing devices and be responsible for transmitting the collected data to a traffic controller 720, such as a data center.

In accordance with various embodiments of the present invention, an entry point used in the data communication scheme 700 can employ different modules or components for collecting, managing and transmitting the collected data. For example, the entry point 702 can comprise a data collector 711 for collecting data, including both remote data 714 and local data 715. Also, the entry point 702 can comprise a data manager 713 for processing the collected data. For example, the data manager 713 can perform data pre-processing such as data compressing in order to improve the efficiency in communicating such information to the traffic controller 720. As shown in FIG. 7, a data transmitter 712 can be employed for transmitting the collected data to the traffic controller 720 via various communication channels 710.

In various embodiments, the entry points 701-703 can be implemented using various computational devices, such as microcontrollers, portable computers, personal computers, switches, routers and servers. For example, an entry point can be implemented on-board of one of more sensing devices. Alternatively, an entry point can be implemented using a separate server or controller that connects to the one of more sensing devices.

In one embodiment, the entry point 702 may have access to the digital signals via various types of digital cables or circuits. For example, the data collector 711 at the entry point 702 can collect local data 715 via the digital cables or circuits that connect to the sensors. Alternatively, the data collector 711 may be connected with one or more sensing devices via fiber optic channels. For example, the data collector 711 at entry point 702 can collect remote data 714 via the fiber optic channels, which has the advantage of supporting high bandwidth data communication over a longer distance. Here, the electrical signal generated at the one or more sensing devices may be converted into optic signals which are transmitted using fiber optic channels. At the entry point 702, the optical signals can be converted back into electrical signals. Then, the data transmitter 712 can transmit the digital signals to the traffic controller 720 via communication infrastructure 710.

In various embodiments, a communication infrastructure, which provides various communication channels 710, can be used to transmit the collected data from the various entry points to the traffic controller 720 (e.g. a data center). The communication infrastructure can take advantage of various types of communication networks.

In accordance of various embodiments, the traffic controller 720 can comprise a central controller 720, which can monitor the traffic condition and coordinate the traffic flow in a road environment based on data collected via various sensing devices. As shown in FIG. 7, the central controller 720 can receive data transmitted from various entry points. Then, a data manager 723 can process the received data for further processing. For example, image data collected by various sensing device may be encoded into various data packets at the various entry points using different codec technologies. Then, the data manager 723 can decode the received data packets and can generate image data that can be displayed on the monitor 721. Additionally, the central controller 720 can employ different processing modules (e.g. a data analyzer 725 using various data analyzation techniques such as neural network algorithms) for further processing the received data. For example, the central controller 720 can detect various events with regard to the traffic condition in the road environment. Also, the central controller 720 can generate different types of alerts when an urgent traffic condition is detected. For example, when a car accident occurs at a particular road section, the central controller may be able to alert the surrounding vehicles and divert the upstream traffic through an alternative route. Thus, the central controller 720 can monitor and control the traffic in a remote road environment.

Additionally, the traffic controller 720 can employ different levels of controllers for monitoring and controlling the traffic in a road environment. For example, the system can employ a regional controller 726 that can be used for monitoring and controlling the traffic for several streets in a region. In another example the system can employ a sectional controller 727 that may be used for regional controller 726 for a particular section of the road.

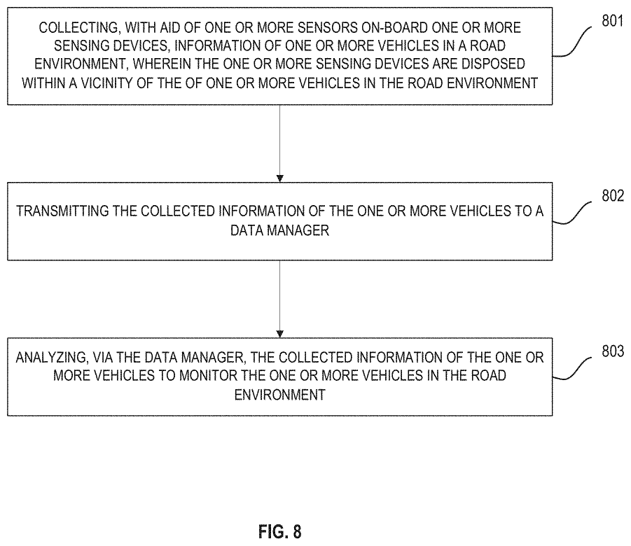

FIG. 8 shows a flowchart of monitoring vehicle traffic, in accordance with various embodiments of the invention. At 801, information is collected, with aid of one or more sensors on-board one or more sensing devices, of one or more vehicles in a road environment. The one or more sensing devices are disposed within a vicinity of the of one or more vehicles in the road environment. In some embodiments, the road environment comprises at least a section of a highway road, a city road, or a rural road. In some embodiments, the one or more sensors comprise at least one of an image sensor, a sonar radar sensor, a temperature sensor, or a pressure sensor.

In some embodiments, the one or more sensing devices are disposed on a pavement surface in the road environment. In some embodiments, the one or more sensing devices are disposed in a raised pavement marker in the road environment. In some embodiments, the one or more sensing devices are disposed along one or more traffic lane dividers in the road environment. In some embodiments, the one or more sensing devices are disposed with one or more traffic control devices in the road environment. In some embodiments, the one or more traffic control devices comprises a marker or a sign on ground surface. In some embodiments, the one or more sensing devices are disposed on a traffic barrier in the road environment. In some embodiments, the one or more sensing devices are configured to face traffic direction in the road environment. In some embodiments, at least one vehicle is an autonomous vehicle.

At 802, the collected information of the one or more vehicles is transmitted to a data manager. In some embodiments, the data manager is associated with a data center. In some embodiments, the data center comprises a central controller, a regional controller, or a sectional controller. At 803, the collected information of the one or more vehicles is analyzed via the data manager to monitor the one or more vehicles in the road environment. In some embodiments, the method may further include transmitting the collected information, via a communication channel, to a vehicle controller. In some embodiments, the communication channel is based on one or more wired or wireless communication protocols. In some embodiments, the method may further include tracking at least one vehicle based on collected data.

With the development of the assisted-driving technology, many cars come equipped with a Lane Departure Warning System (LDWS) to provide a warning to the driver in case of deviation from normal driving. An LDWS may include a heads-up display (HUD), camera, and controller. When the LDWS is enabled, the camera (normally disposed on the side of the vehicle body or incorporated into the rear-view mirror) can capture image data of the road and identify lane markings on the road. The image data can be processed to identify the lane boundaries and the position of the vehicle within the lane. If it is detected that the car is leaving the lane, the LDWS can send a warning signal. The LDWS can also base its warning on the current state of the vehicle. For example, if the vehicle's turn signal is on in the direction in which the vehicle leaves the lane, then no warning may be sent. Typical LDWS systems collect data using visual sensors (e.g., cameras). However, under various weather conditions, the lane markings may not be visible, or may not be able to be reliably identified in the image data. For example, in snowy or rainy weather, the lane markings may be obscured, limiting the usefulness of the LDWS.

Embodiments provide an improved lane departure warning system, which can detect a lane departure event based on vibrations generated when the vehicle drives over lane markers on the roadway. The lane markers may include reflectors, rumble strips, and other objects in or on the roadway which are used to mark lanes instead of, or in addition to, lane marking lines painted on the roadway. In some embodiments, the vibrations may be detected using a plurality of LDWS sensors distributed through the vehicle. The LDWS sensors may include inertial measurement units, linear potentiometers, or other sensors configured to detect vibrations in the suspension system of the vehicle. The LDWS can analyze the vibrations and determine whether they correspond to a lane departure signal. If so, a lane departure warning can be sent.

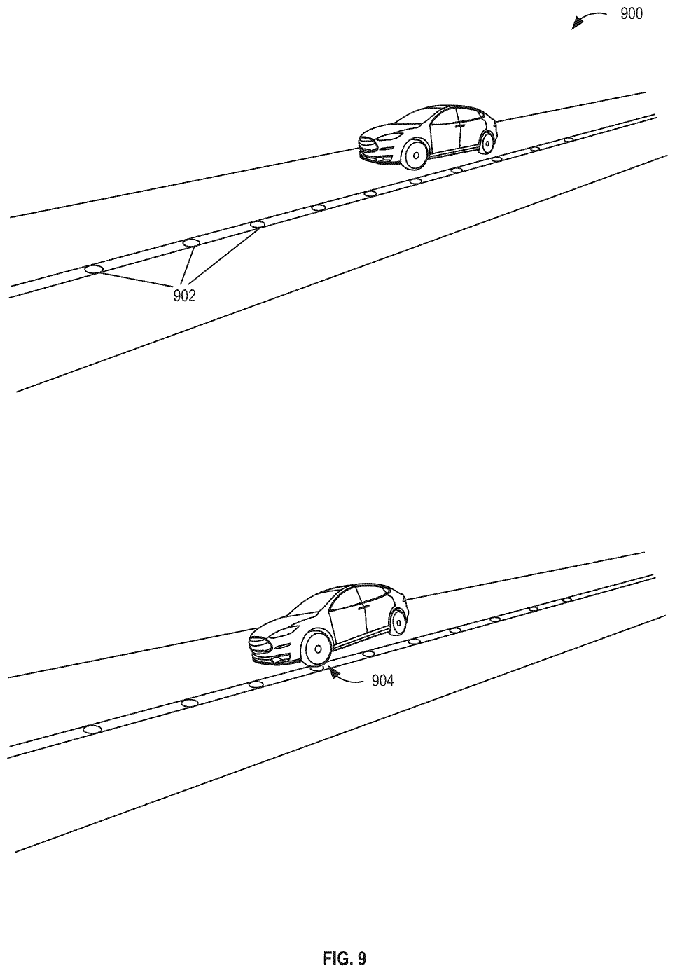

FIG. 9 shows a movable object operating in a road environment 900, in accordance with various embodiments of the invention. As shown in FIG. 9, on certain roads, there are raised pavement markers (RPMs) 902 on the lane markings, e.g., in center lines, shoulder lines, etc., to make the lane markings more visible in some conditions, such as low light conditions, in the rain, etc. When the vehicle drives on these RPMs, as shown at 904, the vehicle will vibrate, and such vibration indicates that the vehicle has departed from the normal lane.

In some embodiments, an LDWS sensor, such as an inertial measurement unit (IMU), linear potentiometer, or other sensor can be mounted in the suspension of the vehicle. For example, each wheel may be associated with an LDWS sensor. Because the RPMs are placed at regular intervals on the roadway, when the vehicle drives on the RPMs, vibrations of a specific frequency will be generated. If the vibration is detected on wheels on one side of the vehicle, then the LDWS can determine that the vehicle has crossed the lane markings and a lane departure warning can be generated.

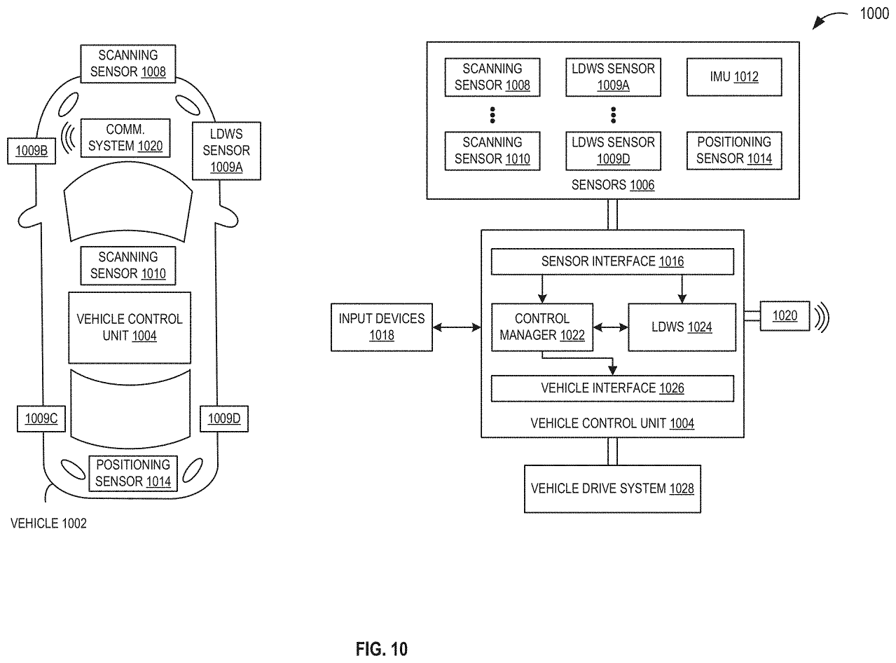

FIG. 10 shows a movable object architecture 1000, in accordance with various embodiments of the invention. As shown in FIG. 10, a movable object 1002 can be a ground vehicle. One of skill in the art would appreciate that any of the embodiments described herein can be applied to any suitable movable object (e.g., an autonomous vehicle, etc.). As used herein, “ground vehicle” may be used to refer to a subset of movable objects that travel on the ground (e.g., cars and trucks), that may be manually controlled by a driver and/or autonomously controlled).

Movable object 102 may include a vehicle control unit 1004 and various sensors 1006, such as scanning sensors 1008 and 1010, LDWS sensors 1009A-1009D, inertial measurement unit (IMU) 1012, and positioning sensor 1014. In some embodiments, scanning sensors 108, 110 can include a LiDAR sensor, ultrasonic sensor, infrared sensor, radar sensor, imaging sensor, or other sensor operable to collect information about the surroundings of the movable object, such as distances to other objects in the surroundings relative to the movable object. The movable object 102 can include a communication system 120, which is responsible for handling the communication between the movable object 102 and other movable objects, a client device, and the movable object 102 via communication system 120. For example, a movable object can include uplink and downlink communication paths. The uplink can be used for transmitting control signals, the downlink can be used for transmitting media, video stream, control instructions for another device, etc. In some embodiments, the movable object can communicate with a client device. The client device can be a portable personal computing device, a smart phone, a remote control, a wearable computer, a virtual reality/augmented reality system, and/or a personal computer. The client device may provide control instructions to the movable object and/or receive data from the movable object, such as image or video data.

In accordance with various embodiments of the present invention, the communication system can communicate using a network, which is based on various wireless technologies, such as WiFi, Bluetooth, 3G/4G/5G, and other radio frequency technologies. Furthermore, the communication system 1020 can communicate using a communication link based on other computer network technologies, such as internet technology (e.g., TCP/IP, HTTP, HTTPS, HTTP/2, or other protocol), or any other wired or wireless networking technology. In some embodiments, the communication link used by communication system 1020 may be a non-network technology, including direct point-to-point connections such as universal serial bus (USB) or universal asynchronous receiver-transmitter (UART).

The communication system 1020 may include any number of transmitters, receivers, and/or transceivers suitable for wireless communication. The communication may be one-way communication, such that data can be transmitted in only one direction. For example, one-way communication may involve only the movable object 1002 transmitting data to the client device 1010, or vice-versa. The data may be transmitted from one or more transmitters of the communication system 1020A of the client device to one or more receivers of the communication system 1020B of the movable object, or vice-versa. Alternatively, the communication may be two-way communication, such that data can be transmitted in both directions between the movable object 1002 and the client device 1010. The two-way communication can involve transmitting data from one or more transmitters of the communication system 1020B to one or more receivers of the communication system 1020A of the client device 1010, and vice-versa.

In accordance with various embodiments of the present invention, the movable object 102 may include a vehicle drive system 1028. The vehicle drive system 1028 can include various movement mechanisms, such as one or more of rotors, propellers, blades, engines, motors, wheels, axles, magnets, nozzles, animals, or human beings. For example, the movable object may have one or more propulsion mechanisms. The movement mechanisms may all be of the same type. Alternatively, the movement mechanisms can be different types of movement mechanisms. The movement mechanisms can be mounted on the movable object 1002 (or vice-versa), using any suitable means such as a support element (e.g., a drive shaft). The movement mechanisms can be mounted on any suitable portion of the movable object 1002, such on the top, bottom, front, back, sides, or suitable combinations thereof.

In some embodiments, one or more of the movement mechanisms may be controlled independently of the other movement mechanisms, for example by an application executing on a client device, vehicle control unit 1004, or other computing device in communication with the movement mechanisms. Alternatively, the movement mechanisms can be configured to be controlled simultaneously. For example, the movable object 10002 can be a front or rear wheel drive vehicle in which the front or rear wheels are controlled simultaneously. Vehicle control unit 1004 can send movement commands to the movement mechanisms to control the movement of movable object 1002. These movement commands may be based on and/or derived from instructions received from a client device, autonomous drive unit, input devices 1018 (e.g., built in vehicle controls, such as an accelerator pedal, brake pedal, steering wheel, seat controls, a touchscreen console display, dashboard display, heads-up display (HUD) etc.), or other entity. In some embodiments, a control manager 1022 can convert the control inputs into a control output that may be sent to the vehicle drive system 1028 through vehicle interface 1026.

The movable object 1002 can include a plurality of sensors 1006. The sensors 1006 can include one or more sensors that may sense the spatial disposition, velocity, and/or acceleration of the movable object 1002 (e.g., with respect to various degrees of translation and various degrees of rotation). The one or more sensors can include various sensors, including global navigation satellite service (GNSS) sensors (e.g., global positioning system (GPS), BeiDou, Galileo, etc.), motion sensors, inertial sensors, proximity sensors, or image sensors. The sensing data provided by the sensors 1006 can be used to control the spatial disposition, velocity, and/or orientation of the movable object 1002 (e.g., using a suitable processing unit and/or control module, such as vehicle control unit 1004). Additionally, or alternatively, the sensors can be used to provide data regarding the environment surrounding the movable object, such as weather conditions, proximity to potential obstacles, location of geographical features, location of manmade structures, and the like. The sensors may also collect information from the roadway. For example, LDWS sensors 1009A-1009D can record vibrations caused by the movable object traveling on the roadway.

In some embodiments, one or more of the sensors 1006 may be coupled to the movable object 1002 via a carrier. The carrier may enable the sensor to move independently of the movable object. For example, an image sensor may be oriented to capture images around the movable object using the carrier to change the image sensor's orientation. This enables images to be captured in various directions independent of the current orientation of the movable object. In some embodiments, the sensor mounted to the carrier may be referred to as a payload.

In some instances, the communications from the movable object, carrier and/or payload may include information from one or more sensors 1006 and/or data generated based on the sensing information. The communications may include sensed information from one or more different types of sensors 1006 (e.g., GNSS sensors, motion sensors, inertial sensor, proximity sensors, or image sensors). Such information may pertain to the position (e.g., location, orientation), movement, or acceleration of the movable object, carrier, and/or payload. Such information from a payload may include data captured by the payload or a sensed state of the payload.

As shown in FIG. 10, each wheel may be associated with a different LDWS sensor 1009A-1009D. In some embodiments, a movable object may include two sensors, one on each side of the car, to detect vibrations occurring on only one side of the car. The sensors may include inertial measurement units configured to record the movement of the suspension as the movable object travels along the roadway. In some embodiments, the sensors may include linear potentiometers, which measure the travel of the suspension on each wheel as the vehicle travels along the road. For example, when the vehicle passes over a bump, e.g., due to a speed bump, a raised reflective marker, a road stud, a cats-eye, a Bott's dot, etc., the wheel and associated suspension system is displaced from its neutral position (e.g., a position corresponding to an average ride height of the movable object). This displacement may be measured by an IMU, linear potentiometer, or other sensor, and the sensor generates sensor data that indicates the displacement. At speed, this displacement manifest as vibrations in the vehicle.

The sensor data can be passed to the LDWS 1024 via sensor interface 1016. Because the LDWS sensors generate data representing the vibrations experienced by the suspension system of the movable object, each sensor is generating data as long as the movable object is moving. In some embodiments, a minimum vehicle speed may be required before sensor data received from the LDWS sensors is analyzed. For example, the vehicle may need to be traveling at least 30 miles per hour before the LDWS sensors can detect a lane change. Raised pavement markers (RPMs) are spaced at regular intervals on highways. For example, in the United States, best practices typically space RPMs at 40 foot intervals. As such, at the minimum LDWS speed of 30 mph, the vehicle is traveling approximately 44 feet per second, which would result in a lane departure signal of 1.1 Hz, as an RPM is hit by the vehicle's wheel just over once per second. At highway speeds of 80 mph, assuming uniform spacing, this lane departure signal may rise to approximately 3 Hz. Different spacings of RPMs will result in different frequency ranges of the expected lane departure signals. More closely spaced RPMs will result in a higher frequency range, while more distantly spaced RPMs will result in a lower frequency range. If sensors are placed at both the front and rear wheels of the vehicle, then the lane departure signal detected by the rear wheel will be offset according to the vehicle's wheelbase.

In some embodiments, LDWS 1024 may noise filter and/or frequency filter the vibration data received from the LDWS sensors 1009A-D. For example, based on the expected spacing of RPMs in the road environment, a bandpass filter may limit the sensor data to that having a frequency falling in the expected lane departure frequency range. In some embodiments, the lane departure frequency range may include an additional threshold range to allow for variations in spacing of the RPMs. For example, in an area with 40 ft RPM spacing, the lane departure frequency range may be 1-6 Hz. Using a bandpass filter may eliminate, or greatly reduce, portions of the sensor data falling outside of this frequency range.

In some embodiments, when a vibration signal is detected, LDWS 1024 can analyze the vibration signal to determine its signal characteristics. For example, the LDWS can determine the amplitude of the vibration signal and frequency of the vibration signal. The LDWS can also obtain driving state information from control manager 1022 and/or sensors 1006, such as the speed and direction of the vehicle. Based on the vibration signal characteristics, and the driving state information, the LDWS can determine whether the vibration signal corresponds to a lane departure signal. For example, the LDWS can determine whether the frequency of the vibration signal matches, within a threshold value, the expected lane departure signal frequency based on the current speed of the vehicle. In some embodiments, LDWS can also compare the amplitude of the vibration signal at bilateral locations on the vehicle. For example, a vibration signal generated due to the impact with an RPM on one side of the vehicle may be transferred to the other side of the vehicle via the frame, body, unibody, etc. of the vehicle 1002. However, the amplitude of the vibration will be significantly lower. As such, if a vibration signal having the same, or substantially the same, frequency is detected at both LDWS sensors 1009A and 1009B, but the amplitude of the vibration signal detected by LDWS sensor 1009A is lower than that detected at 1009B by a threshold value (e.g., one half, one quarter, one tenth, etc.), then LDWS 1024 can determine that the vibration signal is due to the vehicle impacting an RPM on the left side of the vehicle where LDWS sensor 1009B is mounted.

In some embodiments, when a vibration signal is determined to match a lane departure signal, LDWS 1024 can send a lane departure warning to control manager 1022. Control manager 1022 can send the lane departure warning to the driver via input devices 1018. For example, the lane departure warning may cause the steering wheel or seat to vibrate alerting the driver to the lane departure. In some embodiments, an audible or visual warning may be provided to the driver. In some embodiments, control manager 1022 can send an assisted driving instruction to the vehicle drive system 1028 via vehicle interface 1026 in response to the lane departure warning. In some embodiments, the assisted driving instruction may be based on control data received from the LDWS or generated by the control manager in response to the lane departure warning. The control data may be converted by the control manager into vehicle drive system instructions which may cause the vehicle to steer back into the lane. For example, the control manager can cause the vehicle to change direction to bring the vehicle back within the lane markings and/or to change the vehicle's trajectory to be roughly parallel with the lane markings.

In some embodiments, LDWS 1024 may additionally include an image-based land detection system. As discussed, an image-based lane detection system may include a plurality of cameras which may capture image data of the road environment. The cameras may be configured to capture visual image data, infrared image data, and/or image data in other spectra. The LDWS can analyze the image data to identify lane markings. The lane markings may be identified based on painted lane lines, light reflected off reflective RPMs, or other lane markings. If the LDWS determines that the vehicle is approaching, or crossing, the lane markings identified in the image data, the LDWS can send a lane departure warning to the control manager to be communicated to the driver. In some embodiments, the LDWS may generate control data based on the image data. For example, the vehicle's trajectory and speed relative to the lane markings may be determined based on the image data. The control data, when executed by the control manager, may cause the vehicle to steer back into the lane. The control data may include steering adjustments to alter the trajectory of the vehicle away from the lane markings and to redirect the vehicle onto a trajectory roughly parallel with the lane markings. The control data may be in addition to the lane departure warning or may be sent instead of the warning.

In some embodiments, the LDWS may include a mapping manager that implements one or more Simultaneous Location and Mapping (SLAM) techniques that may use the image data collected by the cameras and/or other sensor data obtained from e.g., a LiDAR sensor, inertial measurement unit (IMU), gyroscope, etc., to generate a local map of the road environment. The mapping manager can monitor the vehicle's position within the local map and compare that position to lane markings identified in the image data, or expected lane markings based on standard lane dimensions for the road environment. If the vehicle's position in the local map is determined to be within a threshold distance of the lane markings or expected lane markings, then the LDWS can generate a lane departure warning as discussed above. Additionally, or alternatively, control data may be generated to cause the vehicle to change trajectory and increase the distance between the vehicle and the lane markings. The control data can be generated by the LDWS or the control manager, and may be converted by the control manager into vehicle drive system instructions that cause the vehicle to change directions accordingly.

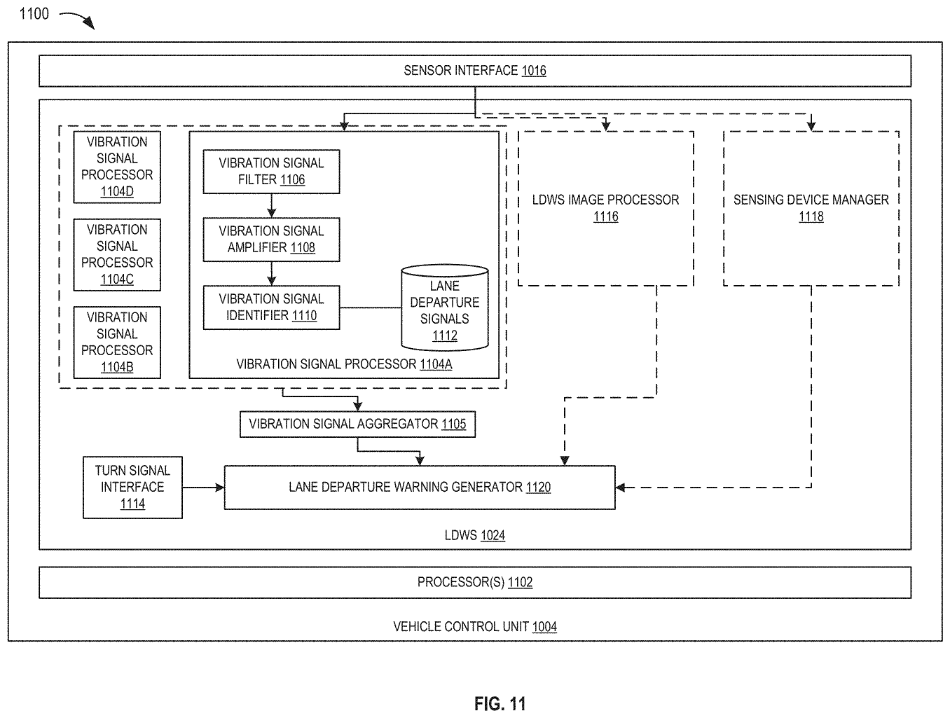

FIG. 11 shows an example 1100 of a vehicle control system including a lane departure warning system (LDWS), in accordance with various embodiments of the invention. As shown in FIG. 11, an LDWS 1024 may execute on one or more processors 1102 of vehicle control unit 1004. The one or more processors 1102 may include CPUs, GPUs, GPGPUs, FGPAs, SoCs, or other processors, and may be part of a parallel computing architecture implemented by vehicle control unit 1004. The LDWS 1024 may receive sensor data via sensor interface 1016 and generate lane departure warnings based on the sensor data. The LDWS 1024 can include a plurality of vibration signal processors 1104A-D corresponding to the LDWS sensors on the vehicle, a turn signal interface 1114, an LDWS image processor 1116, a road sensor manager 1118, and a lane departure warning generator 1120. Although four vibration signal processors are shown, in various embodiments more or fewer vibration processors may be utilized depending on the number of LDWS sensors in use. In some embodiments, a single vibration signal processor may processor vibration data from all of the LDWS sensors in use.

In some embodiments, vibration data may be received by the vibration signal processors 1104A-D via sensor interface 1016 when the vehicle is traveling at a speed greater than or equal to a minimum LDWS speed (e.g., 30 mph). In various embodiments, the vibration data may be analyzed in the time domain or the frequency domain. As discussed, the vibration data can be passed through a vibration signal filter 1106, e.g., to remove noise and/or isolate a portion of the sensor data most likely to correspond to a lane departure signal. In some embodiments, time domain vibration data may be noise filtered using, e.g., a linear filter such as a moving-average filter, or a non-linear filter such as a Kalman filter, or a combination of such filters. In some embodiments, the sensor data can be transformed into the frequency domain, e.g., using a Fourier transform, and a low pass, high pass, bandpass, or other filter, digital or analog, may be applied to the sensor data. In some embodiments, after the sensor data has been filtered, the resulting vibration data can be amplified by vibration signal amplifier 1108. In some embodiments, the vibration signal may be filtered and amplified using the same logic and/or circuitry.

The resulting signal can be analyzed by vibration signal identifier 1110 which may determine the signal characteristics (e.g., amplitude and frequency) of the vibration signal. The vibration signal processor can obtain the vehicle speed via sensor interface 1016 or control manager 1022 and look up a corresponding lane departure signal in lane departure signals data store 1112, based on the current vehicle speed. The lane departure signals data store may include expected lane departure signal characteristics indexed at a plurality of vehicle speeds (e.g., between the minimum LDWS speed and a maximum LDWS speed). The vibration signal identifier can compare the vibration signal characteristics to the lane departure signal characteristics obtained from the lane departure signals data store 1112. If the signal characteristics match, within a threshold value (e.g., within a 10%, 15%, or other error rate), then the vibration signal processor can output data indicating that the vibration signal processor has identified a lane departure signal from a corresponding LDWS sensor.

In various embodiments, a vibration signal aggregator 1105 can receive the output data from each vibration signal processor 1104A-D and determine whether the output data corresponds to a likely lane departure event. In some embodiments, each vibration signal processor can push the output data to the lane departure warning aggregator 1120 when a lane departure is detected. For example, if all sensors are indicating a lane departure signal has been detected, then all wheels (or both sides of the vehicle) are vibrating at roughly rates. This likely indicates roadway vibrations (e.g., due to speed bumps, washboard roads, poor road condition, etc.) because it is affecting both sides of the vehicle. If, however, the sensors indicate that the vibration data is bilaterally asymmetric (e.g., detected primarily on only one side), then the vibration data is likely associated with a lane departure on that side of the vehicle. The vibration signal aggregator 1105 can output a lane departure warning message to lane departure warning generator 1120. In some embodiments, the lane departure warning message can include an indicator that a lane departure has been detected (e.g., a bit may represent whether a lane departure warning has been detected) and may further indicate the side of the vehicle where the lane departure was detected (e.g., a second bit may represent “right” or “left”).

As shown in FIG. 11, lane departure warning generator 1120 may receive lane departure warning messages from vibration signal aggregator 1105 and, optionally, other sensor data processors, such as LDWS image processor 1116 and sensing device manager 1118. In some embodiments, LDWS image processor 1116 may operate as traditional LDWS systems, by analyzing image data captured by sensors 1106 to identify lane markings and the vehicle's position. If the vehicle's position approaches and/or crosses the identified lane markings, the LDWS image processor 1116 can output a lane departure message indicating that a lane departure has been detected and the side of the vehicle on which the lane departure was detected. In some embodiments, sensing devices deployed in the road environment, such as those described above with respect to FIGS. 1-8, may transmit image, position, and/or vibration data to the vehicle 1002. This data may be obtained by LDWS sensors 1009A-D. For example, LDWS sensors 1009A-D may include wireless receivers capable of receiving sensor data from the sensing devices in the road environment. For example, the sensing devices in the road environment, may include imaging devices capable of capturing image data that includes representations of the vehicle and the lane as the vehicle is traveling. The sensing device can determine a position of the vehicle relative to the lane based on the image data and the known position of the sensing device. If the vehicle position is too close to the lane marking (or over the lane marking), then the sensing device can output a message to the LDWS sensors indicating the lane departure. Additionally, or alternatively, the sensing devices in the road environment may include a pressure sensor, vibration sensor, or other sensor capable of detecting an impact on the sensing device (e.g., due to a vehicle tire running over the sensing device). Similarly, if the sensing device detects an impact, the sensing device can transmit a lane departure message to the nearest LDWS sensor (e.g., corresponding to the wheel, or side of the vehicle, where the impact occurred). In some embodiments, the sensing devices in the road environment may output a control signal to cause the vehicle to return to the lane in addition, or as an alternative, to the lane departure message. The LDWS sensor that receives the control signal can pass the control signal to control manager 1022 to be converted into a control output signal and passed to the vehicle drive system 1028 to change the direction of the vehicle 1002.

In some embodiments, lane departure warning generator 1120 can receive lane departure warnings from the vibration signal aggregator 1105, LDWS image processor 1116, and sensing device manager 1118. The lane departure warning generator can also receive data from a turn signal interface 1114, which indicates whether a turn signal is currently active. If a turn signal is active, then any LDWS warnings corresponding to that side of the vehicle may be ignored, and no lane departure warning is generated. If a turn signal is not active, or if the active turn signal is on the opposite side of the car from the lane departure warnings, then lane departure warning generator 1120 can generate a lane departure warning. In some embodiments, if multiple lane departure warning messages are received (e.g., from vibration signal aggregator 1105, LDWS image processor 1116 and/or sensing device manager 1118), the lane departure warning generator may generate a lane departure warning if any one of them produces a lane departure warning message. This enables the vibration-based system to serve as a backup to the image-based system if, for example, weather or road conditions make identification of lane markings difficult or unreliable in the image data. In some embodiments, a lane departure warning may only be generated if all systems are in agreement that a lane departure has occurred.

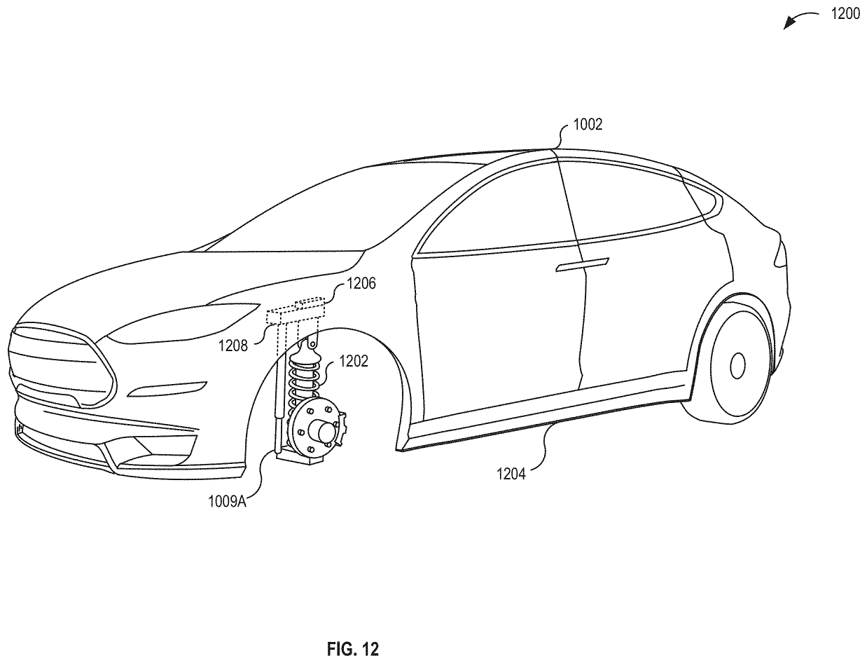

FIG. 12 shows an example 1200 of a movable object including LDWS sensors, in accordance with various embodiments of the invention. As discussed, movable object 1002 may include various LDWS sensors, such as LDWS sensor 1009A. As shown in FIG. 12, the LDWS sensor 1009A can be connected to the suspension system 1202 associated with a wheel. In some embodiments, each wheel may be associated with a different LDWS sensor. In some embodiments, the front two wheels may each be associated with a different LDWS sensor, while the rear wheels may not be associated with LDWS sensors. In some embodiments, the LDWS sensors may be coupled to the movable object in different locations. For example, an LDWS sensor may be mounted along the frame, body, unibody, or other portion of the movable object, at a point between the axels, such as location 1204. In some embodiments, the LDWS sensor may include an inertial measurement unit 1206. The IMU 1206 can be coupled a point 1208 in the suspension where it meets the vehicle frame, body, unibody, etc. In some embodiments, the LDWS sensors may be mounted on each side of the vehicle between the front and rear wheels.

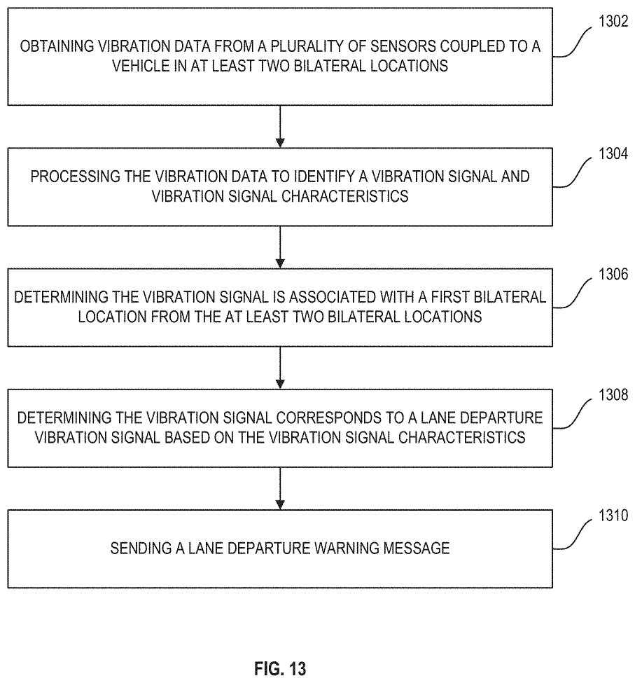

FIG. 13 shows a flowchart of a method for generating lane departure warnings, in accordance with various embodiments of the invention. At 1302, vibration data can be obtained from a plurality of sensors coupled to a vehicle in at least two bilateral locations. In some embodiments, the plurality of sensors includes a plurality of inertial measurement units. In some embodiments, each wheel of the vehicle is associated with a different sensor from the plurality of sensors. In some embodiments, obtaining vibration data from a plurality of sensors coupled to a vehicle in at least two bilateral locations, can further include receiving the vibration data from each sensor of the plurality of sensors by a computing device coupled to the vehicle. Each sensor of the plurality of sensors can be in wireless communication with the computing device. At 1304, the vibration data can be processed to identify a vibration signal and vibration signal characteristics. In some embodiments, processing the vibration data to identify a vibration signal and vibration signal characteristics, can further include noise filtering the vibration data to identify the vibration signal.

At 1306, the vibration signal can be determined to be associated with a first bilateral location from the at least two bilateral locations. In some embodiments, the at least two bilateral locations include a driver's side location and a passenger's side location. In some embodiments, determining the vibration signal is associated with a first bilateral location from the at least two bilateral locations, can further include determining that the vibration data from a first subset of the plurality of sensors is associated with the vibration signal having an amplitude greater than a first threshold, determining that the vibration data from a second subset of the plurality of sensors is associated with the vibration signal having an amplitude less than a second threshold, and identifying the first bilateral location associated with the first subset of the plurality of sensors.

At 1308, the vibration signal can be determined to correspond to a lane departure vibration signal based on the vibration signal characteristics. In some embodiments, determining the vibration signal corresponds to a lane departure signal based on the vibration signal characteristics, can further include receiving, from a lane departure warning system (LDWS) coupled to the vehicle, a message indicating that the LDWS has identified a lane departure condition. In some embodiments, the LDWS includes one of a camera-based LDWS, laser-based LDWS, or infrared-based LDWS. In some embodiments, determining the vibration signal corresponds to a lane departure vibration signal based on the vibration signal characteristics, can further include obtaining a driving state for the vehicle, the driving state including vehicle speed and vehicle direction, obtaining the lane departure vibration signal associated with the vehicle speed, and matching the vibration signal to the lane departure vibration signal within a threshold. In some embodiments, the vibration signal and the lane departure vibration signal are both time-domain signals. In some embodiments, the vibration signal and the lane departure vibration signal are both frequency-domain signals. In some embodiments, determining the vibration signal corresponds to a lane departure vibration signal based on the vibration signal characteristics may further include receiving an impact signal from at least one sensing device disposed in a road environment in which the vehicle is traveling.

At 1310, a lane departure warning message can be sent. In some embodiments, the method may further include receiving acknowledgement of the lane departure warning message, and dismissing the lane departure warning message. In some embodiments, the lane departure warning includes at least one of an audible alert, a visual alert, or a haptic alert.

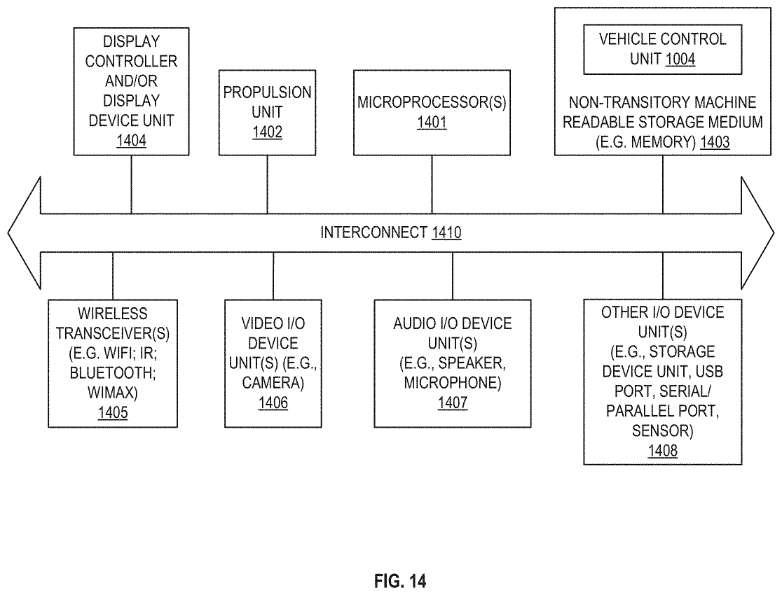

FIG. 14 is an exemplary illustration of a movable object, in accordance with various embodiments of the present invention. The computing device 1400 is an electronic device including many different components. These components can be implemented as integrated circuits (ICs), discrete electronic devices, or other modules adapted to a circuit board such as a motherboard or add-in card of a computing system, or as components otherwise incorporated within a chassis of the computing system. In some embodiments, all or a portion of the components described with respect to FIG. 14 may be included in a computing device that is coupled to a movable object. In some embodiments, computing device 1400 may be a movable object. Note also that the computing device 1400 is intended to show a high-level view of many components of the computing system. However, it is to be understood that additional components may be present in certain implementations and furthermore, different arrangements of the components shown may occur in other implementations.

In one embodiment, the computing device 1400 includes one or more microprocessors 1401, propulsion unit 1402, non-transitory machine-readable storage medium 1403, and components 1404-1408 that are interconnected via a bus or an interconnect 1410. The one or more microprocessor 1401 represent one or more general-purpose microprocessors such as a central processing unit (CPU), graphics processing unit (GPU), general purpose graphics processing unit (GPGPU), or other processing device. More particularly, the microprocessor 1401 may be a complex instruction set computing (CISC) microprocessor, reduced instruction set computing (RISC) microprocessor, very long instruction word (VLIW) microprocessor, or microprocessor implementing other instruction sets, or microprocessors implementing a combination of instruction sets. Microprocessor 1401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

The one or more microprocessors 1401 may communicate with non-transitory machine-readable storage medium 1403 (also called computer-readable storage medium), such as magnetic disks, optical disks, read only memory (ROM), flash memory devices, and phase change memory. The non-transitory machine-readable storage medium 1403 may store information, including sequences of instructions, such as computer programs, that are executed by the one or more microprocessors 1401, or any other device units. For example, executable code and/or data of a variety of operating systems, device drivers, firmware (e.g., input output basic system or BIOS), and/or applications can be loaded in the one or more microprocessors 1401 and executed by the one or more microprocessors 1401.

The non-transitory machine-readable storage medium 1403 may include logic to implement all or portions of the functionality described above with respect to at least the vehicle control unit 1004 and its various components (e.g., control manager 1022, LDWS 1024, vibration signal processors 1104A-1104D, lane departure warning generator 1120, LDWS image processor 1116, sensing device manager 1118, etc.) which includes instructions and/or information to perform operations discussed herein above. The non-transitory machine-readable storage medium 1403 may also store computer program code, executable by the one or more microprocessor 1401, to perform operations discussed herein above in methods 900 and 1000 in accordance with various embodiments of the present invention.

The propulsion unit 1402 may include one or more devices or systems operable to generate forces for sustaining controlled movement of the computing device 1400. The propulsion unit 1402 may share or may each separately include or be operatively connected to a power source, such as a motor (e.g., an electric motor, hydraulic motor, pneumatic motor, etc.), an engine (e.g., an internal combustion engine, a turbine engine, etc.), a battery bank, etc., or combinations thereof. The propulsion unit 1402 may include one or more actuators to control various components of the movable object in response to instructions (e.g., electrical inputs, messages, signals, etc.) received from the vehicle control unit. For example, the actuators may regulate fluid flow, pressure, air flow and other aspects of the vehicle drive system 128 (e.g., braking system, steering system, etc.) by controlling various valves, flaps, etc. within the vehicle drive system. The propulsion unit 1402 may also include one or more rotary components connected to the power source and configured to participate in the generation of forces for sustaining controlled flight. For instance, rotary components may include rotors, propellers, blades, nozzles, etc., which may be driven on or by a shaft, axle, wheel, hydraulic system, pneumatic system, or other component or system configured to transfer power from the power source. The propulsion unit 1402 and/or rotary components may be adjustable with respect to each other and/or with respect to computing device 1400. The propulsion unit 1402 may be configured to propel computing device 1400 in one or more vertical and horizontal directions and to allow computing device 1400 to rotate about one or more axes. That is, the propulsion unit 1402 may be configured to provide lift and/or thrust for creating and maintaining translational and rotational movements of computing device 1400.

The computing device 1400 may further include display control and/or display device unit 1404, wireless transceiver(s) 1405, video I/O device unit(s) 1406, audio I/O device unit(s) 1407, and other I/O device units 1408 as illustrated. The wireless transceiver 1405 may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof.

The video I/O device unit 1406 may include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips and conferencing. The video I/O device unit 1406 may be a 4K camera/camcorder in one embodiment.

An audio I/O device unit 1407 may include a speaker and/or a microphone to facilitate voice-enabled functions, such as voice recognition, voice replication, digital recording, and/or telephony functions. Other device units 1408 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. The device units 1408 may further include certain sensors coupled to the interconnect 1410 via a sensor hub (not shown), while other devices such as a thermal sensor, an altitude sensor, an accelerometer, and an ambient light sensor may be controlled by an embedded controller (not shown), dependent upon the specific configuration or design of the computing device 1400.

Many features of the present invention can be performed in, using, or with the assistance of hardware, software, firmware, or combinations thereof. Consequently, features of the present invention may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present invention can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present invention can be incorporated in software and/or firmware for controlling the hardware of a processing system, and for enabling a processing system to interact with other mechanism utilizing the results of the present invention. Such software or firmware may include, but is not limited to, application code, device drivers, operating systems and execution environments/containers.

Features of the invention may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the invention.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for monitoring vehicle traffic, comprising:
collecting, with aid of one or more sensors on-board one or more sensing devices, information of one or more vehicles in a road environment, wherein the one or more sensing devices are disposed within a vicinity of the of one or more vehicles in the road environment;
transmitting the collected information of the one or more vehicles to a data manager; and
analyzing, via the data manager, the collected information of the one or more vehicles to monitor the one or more vehicles in the road environment.

2. The method of claim 1, wherein the road environment comprises at least a section of a highway road, a city road, or a rural road.

3. The method of claim 1, wherein the one or more sensing devices are disposed on a pavement surface in the road environment.

4. The method of claim 1, wherein the one or more sensing devices are disposed in a raised pavement marker in the road environment.

5. The method of claim 1, wherein the one or more sensing devices are disposed along one or more traffic lane dividers in the road environment.

6. The method of claim 1, wherein the one or more sensing devices are disposed with one or more traffic control devices in the road environment.

7. The method of claim 6, wherein the one or more traffic control devices comprises a marker or a sign on ground surface.

8. The method of claim 1, wherein the one or more sensing devices are disposed on a traffic barrier in the road environment.

9. The method of claim 1, wherein the one or more sensing devices are configured to face traffic direction in the road environment.

10. The method of claim 1, wherein the data manager is associated with a data center.

11. The method of claim 10, wherein the data center comprises a central controller, a regional controller, or a sectional controller.

12. The method of claim 1, further comprising transmitting the collected information, via a communication channel, to a vehicle controller.

13. The method of claim 12, wherein the communication channel is based on one or more wired or wireless communication protocols.

14. The method of claim 1, wherein at least one vehicle is an autonomous vehicle.

15. The method of claim 1, wherein at least one vehicle is an autonomous vehicle.

16. The method of claim 1, wherein the one or more sensors comprise at least one of an image sensor, a sonar radar sensor, a temperature sensor, or a pressure sensor.

17. The method of claim 1, further comprising tracking at least one vehicle based on collected data.

18. An vehicle monitoring system, comprising:
one or more sensing devices disposed in a road environment;
one or more sensors on-board the one or more sensing devices, wherein said one or more sensors operate to collect information of one or more vehicles in the road environment, and
a data manager, running on one or more microprocessors, wherein the data manager operates to
receive the collected information of the one or more vehicles; and
analyze the collected information of the one or more vehicles to monitor the one or more vehicles in the road environment.

19. The vehicle monitoring system of claim 18, wherein the one or more sensors comprise at least one of an image sensor, a sonar radar sensor, a temperature sensor, or a pressure sensor.

20. A non-transitory computer-readable medium with instructions stored thereon, that when executed by a processor, perform the steps comprising:
collecting, with aid of one or more sensors on-board one or more sensing devices, information of one or more vehicles in a road environment, wherein the one or more sensing devices are disposed within a vicinity of the of one or more vehicles in the road environment;
transmitting the collected information of the one or more vehicles to a data manager; and
analyzing, via the data manager, the collected information of the one or more vehicles to monitor the one or more vehicles in the road environment.
